(19) United States
(12) Patent Application Publication
(10) Pub. No.: US 2019/0143768 A1
(43) Pub. Date: May 16, 2019

(54) WHEEL SUPPORTING TOOL AND METHOD FOR USING THE SAME

(71) Applicant: SUMMIT TOOL COMPANY, Akron, OH (US)

(72) Inventor: Roger KLISKEY, Akron, OH (US)

(21) Appl. No.: 16/182,803

(22) Filed: Nov. 7, 2018

Related U.S. Application Data
(60) Provisional application No. 62/585,582, filed on Nov. 14, 2017.

(51) Int. Cl. B60C 25/14

(52) U.S. Cl. CPC B60C 25/14

(57) ABSTRACT

A wheel supporting device for enabling the seating of bead of a tire concentrically on a wheel rim of a wheel and tire assembly when the assembly is in a vertical orientation. The device includes a main body member having a first end and a second end; a means for holding the device on a top of the tire, a means for engaging the device with an underside of the wheel rim, a means for adjusting the position of the engaging means, and a means for linking the engaging means with the adjusting means. The holding means is connected to the first end of the main body member, the engaging means is operatively connected to the second end of the main body member, and the adjusting means is operatively connected to the main body member.

### CROSS-REFERENCE TO RELATED APPLICATIONS

This application claims the benefit of U.S. Provisional Application Ser. No. 62/585,582 entitled “Wheel Supporting Tool and Method for Using the Same” filed Nov. 14, 2017, which is incorporated herein by reference in its entirety.

### FIELD OF THE INVENTION

The present invention is generally directed toward a wheel supporting and tire bead centering device. More particularly, the present invention is directed to device usable to ensure that the tire bead and the wheel, of a tire and wheel assembly, are concentrically aligned during, and therefore, after the seating the bead of a tire onto a wheel. More specifically, the present invention is directed to a device that ensures that the tire bead and the wheel, of a tire and wheel assembly, are concentrically aligned during, and therefore, after seating the bead of a tire onto a wheel, when the tire and wheel assembly is in a standing upright or vertical position.

### BACKGROUND OF THE INVENTION

After a tubeless tire is mounted on a rim, the bead of the tire must be seated in order to inflate the tire. If the bead is concentric with the rim when it is seated, the tire will be concentric with the wheel when it is inflated. Having a concentric bead is important because, if the bead is concentrically aligned with the rim of the wheel, then the stress on the tire bead will be even all the way around. An even tire bead ensures the concentric alignment on the wheel, which ensures that the tire tread will be round, allowing the tire to roll smoothly on a road and/or highway. If the tire bead is not concentric with the rim of the wheel when it is seated, the tire will not be concentrically aligned with the wheel when it is inflated, and, to varying degrees, stress on the bead will then be distributed unevenly around the rim, and the tire tread will be oblong, or egg-shaped, tending to bounce as it rolls on the road and/or highway. This causes poor ride quality and premature and uneven tire wear, both of which may cause serious safety concerns.

Tires that are mounted manually with tire working tools are generally mounted in a horizontal position, that is, flat on the floor. Concentricity between the bead and the rim after seating the bead in this position is normally not a problem, as the bead is not subject to any localized stress anywhere around its circumference. With the bead seated in such a manner, the tire and wheel assembly may then be lifted to a standing position, placed into an inflation cage, and inflated without concern about concentricity. However, some tire changing shops use powerful automated equipment that mounts tires on wheels when the tire and wheel assembly is in a vertical or upright position.

The freshly mounted tire and wheel assembly is then rolled from the mounting machine for bead seating and inflation. Ideally, the assembly is then dropped into a horizontal position. This drop into a horizontal position will send a shock to the tire/wheel assembly that jolts the two components (that is the tire and the wheel), and causes them to “seek” their most “comfortable, relaxed” (concentric) orientation. The stress around the circumference of the bead will then be even, and the bead will be seated in a concentric fashion. The assembly can then be lifted to a standing or upright (i.e., vertical) position again, placed into an inflation cage, and inflated without concern about concentricity.

However, some of these tire and wheel assemblies can weigh up to 400 pounds or more, and many technicians habitually choose to seat the bead while the assembly is still in the standing or vertical position, thus circumventing the needed drop of the assembly before seating the bead. While this common practice definitely saves time and greatly decreases effort, there are often undesirable consequences.

With the tire and wheel assembly in the standing upright or vertical position, the weight of the wheel, which may be 200 pounds or more, presses down against the lower portion of the tire bead, causing compression of the bottom portion of the tire and deformation the tire bead in that bottom portion of the tire, while also creating a gap between the tire bead and wheel rim at the top portion of the tire and tire bead above the wheel. Seating the bead in this position, with these varying stresses around the bead, will cause the bead to seat in a nonconcentric or misaligned orientation.

Therefore, there is a need for a device to lift and support the wheel of a tire and wheel assembly in a standing or vertical position, in order to facilitate and ensure the concentric seating of the tire bead on the rim of the wheel.

### SUMMARY OF THE INVENTION

The present invention provides a wheel supporting device for enabling the seating of a bead of a tire concentrically on a rim of a wheel and tire assembly while the assembly is in a vertical orientation. The device includes a main body member having a first end and a second end; a means for holding the device on the top of the tire, the holding means connected to the first end of the main body member; a means for engaging the device with the underside of the wheel rim at the top of the wheel while in the vertical position, the engaging means being operatively connected to the second end of the main body member; a means for adjusting the position of the engaging means, the adjusting means operatively connected to the main body member; and a means for linking the engaging means with the adjusting means.

In one or more other embodiments, the device, as above, may further include holding means that is rotatably connected to the first end of the main body member. Alternatively or in addition, the device may include the holding means that may be a rotatable height-adjusting block. In one or more embodiments, the height adjusting block may be rotatable between a first position and a second position such that the first position corresponds to a wheel of a first size range and the second position corresponds to a wheel of a second size range and wherein the first size is smaller than the second size. The majority of large truck tires fit into one of these two ranges.

In one or more other embodiments, any of the devices, as above, may further include a first connecting means operatively connecting the engaging means to the second end of the main body member and a second connecting means operatively connecting the adjusting means to the main body member. In one or more of these embodiments, the linking means may be secured to both the first connecting means and the second connecting means. In one or more of these embodiments, both the first and second connecting means is a clevis connector. Alternatively, in other embodiments, the linking means may comprise two parallel linking arms.

In one or more embodiments, the adjustment means of any of the devices above may be adjustable to a first position and a second position, wherein the first position corresponds to the engaging means being in a non-engaged position with the underside of the wheel rim and the second position corresponds to the engaging means being in an engaged position with the underside of the wheel rim at the top of the wheel. In one or more of these embodiments, the engaged position corresponds to the bead of a tire being concentrically seated on the wheel rim.

In one or more embodiments, the engaging means of any of the devices may be a lifting arm. In one or more of these embodiments, the lifting arm may include a non-skid and non-marring tip member covering an end of the lifting arm.

In one or more embodiments, the adjustment means of any of the devices may be a lever arm.

Another aspect of the invention provides a method for concentrically centering beads of a tire on a wheel rim of a wheel and tire assembly when the assembly is in a vertical orientation, the method comprising the steps of: providing a wheel supporting device comprising:
i. a main body member having a first end and a second end;
ii. a means for holding the device on a top of the tire, the holding means connected to the first end of the main body member;
iii. a means for engaging the device with an underside of the wheel rim, said engaging means operatively connected to the second end of the main body member
iv. a means for adjusting the position of the engaging means, the adjusting means operatively connected to the main body member; and
v. a means for linking the engaging means with the adjusting means;
   placing the wheel supporting device in a position such that the holding means are positioned on the top of the tire and the engaging means are in a position adjacent the underside of the wheel rim; and adjusting the adjustment means such that the engaging means moves and engages the underside of the wheel rim so as to concentrically center the bead of the tire on the wheel rim.

Another aspect of the invention provides a wheel supporting device for enabling the seating of a bead of a tire concentrically on a wheel rim of a wheel and tire assembly wherein the assembly is in a vertical orientation and placed within a tire cage. The device includes a main body member having a first end and a second end; a means for holding the device on a top of the tire cage, said holding means connected to the first end of the main body member. The device further includes a means for engaging the device with an underside of the wheel rim, the engaging means operatively connected to the second end of the main body member. Still further, the device includes a means for adjusting the position of the engaging means, the adjusting means operatively connected to the main body member; and a means for linking the engaging means with the adjusting means.

In one or more other embodiments, the device, as above, may further comprise a first connecting means operatively connecting the engaging means to the second end of the main body member and a second connecting means operatively connecting the adjusting means to the main body member.

In one or more other embodiments, the linking means may be secured to both the first connecting means and the second connecting means.

In one or more other embodiments, the adjustment means may be adjustable to a first position and a second position, wherein the first position corresponds to the engaging means being in a non-engaged position with the underside of the wheel rim and the second position corresponds to the engaging means being in an engaged position with the underside of the wheel rim, and wherein the engaged position corresponds to the beads of a tire being concentrically seated on the wheel rim. In one or more embodiments with any of the devices, as above, both the first and second connecting means may be a clevis connector.

In one or more other embodiments, the linking means may comprise two parallel linking arms, wherein the engaging means is a lifting arm including a non-skid and non-marring tip member covering an end of the lifting arm, and wherein the adjustment means is a lever arm.

It will be appreciated that the device of the present invention provides a device to lift and support the wheel of a tire and wheel assembly in a standing or vertical position, in order to facilitate and ensure the concentric seating of the tire bead on the rim of the wheel. Advantageously, the device of the present invention enables users to maintain the tire and wheel assembly in the vertical position after mounting for proper bead seating and inflation, such that the tire bead will be properly concentrically seated around the rim of the wheel.

### BRIEF DESCRIPTION OF THE DRAWINGS

For a more complete understanding of the features and advantages of the present invention, reference is now made to the detailed description of the invention along with the accompanying figures in which:

FIG. 1 is a fully exploded perspective view of the individual component parts of one embodiment of the wheel supporting device of the present invention;

FIG. 2 is a partially exploded perspective view the wheel supporting device of FIG. 1 showing the various subassemblies of the present invention in an assembled state;

FIG. 3 is a perspective view of the wheel supporting device of FIG. 1 wherein the adjustment means is in a first position and the holding means is in a first position;

FIG. 4 is a perspective view of the wheel supporting device of FIG. 1 wherein the adjustment means is in a second position and the holding means is in a first position;

FIG. 5 is a perspective view of the wheel supporting device of FIG. 1 wherein the adjustment means is in a first position and the holding means is in a second position;

FIG. 6 is a perspective view of the wheel supporting device of FIG. 1 wherein the adjustment means is in a second position and the holding means is in a second position;

FIG. 7A is a side view of the wheel supporting device of FIG. 1 in position atop a cutaway view of a wheel and tire assembly with the assembly in a vertical orientation wherein the adjustment means is in a first position such that the engaging means is in a position adjacent the underside of a wheel rim and the holding means is in a first position on top of the tire;

FIG. 7B is a close up side view of the intersection of the top portion of the wheel of FIG. 7A and a top portion of the bead of FIG. 7A;

FIG. 7C is a close up side view of the intersection of the bottom portion of the wheel of FIG. 7A and a bottom portion of the bead of FIG. 7A;

FIG. 8A is a side view of the wheel supporting device of FIG. 1 in position atop a cutaway view of a wheel and tire assembly with the assembly in a vertical orientation wherein the adjustment means is in a second position such that the engaging means is engaged with the underside of a wheel rim and the holding means is in a first position on top of the tire;

FIG. 8B is a close up side view of the intersection of the top portion of the wheel of FIG. 8A and a top portion of the bead of FIG. 8A;

FIG. 8C is a close up side view of the intersection of the bottom portion of the wheel of FIG. 8a and a bottom portion of the bead of FIG. 8A;

FIG. 9A is a side view of the wheel supporting device of FIG. 1 in position atop a cutaway view of a wheel and tire assembly with the assembly in a vertical orientation wherein the adjustment means is in a first position such that the engaging means is in a position adjacent the underside of a wheel rim and the holding means is in a second position on top of the tire;

FIG. 9B is a close up side view of the intersection of the top portion of the wheel of FIG. 9A and a top portion of the bead of FIG. 9A;

FIG. 9C is a close up side view of the intersection of the bottom portion of the wheel of FIG. 9A and a bottom portion of the bead of FIG. 9A;

FIG. 10A is a side view of the wheel supporting device of FIG. 1 in position atop a cutaway view of a wheel and tire assembly with the assembly in a vertical orientation wherein the adjustment means is in a second position such that the engaging means is engaged with the underside of a wheel rim and the holding means is in a second position on top of the tire;

FIG. 10B is a close up side view of the intersection of the top portion of the wheel of FIG. 10A and a top portion of the bead of FIG. 10A;

FIG. 10C is a close up side view of the intersection of the bottom portion of the wheel of FIG. 10A and a bottom portion of the bead of FIG. 10A;

FIG. 11 is a side view of a wheel supporting device of one embodiment of the present invention in position atop a cutaway view of a wheel and tire assembly placed within a tire cage with the assembly in a vertical orientation wherein an adjustment means is in a first position such that an engaging means is in a position adjacent the underside of a wheel rim and a holding means is in a first position on top of the tire cage; and

FIG. 12 is a side view of a wheel supporting device as shown in FIG. 11 in position atop a cutaway view of a wheel and tire assembly placed within a tire cage with the assembly in a vertical orientation wherein an adjustment means is in a second position such that the engaging means is engaged with the underside of a wheel rim and the holding means is in a second position on top of the tire cage.

### DETAILED DESCRIPTION OF ILLUSTRATIVE EMBODIMENTS

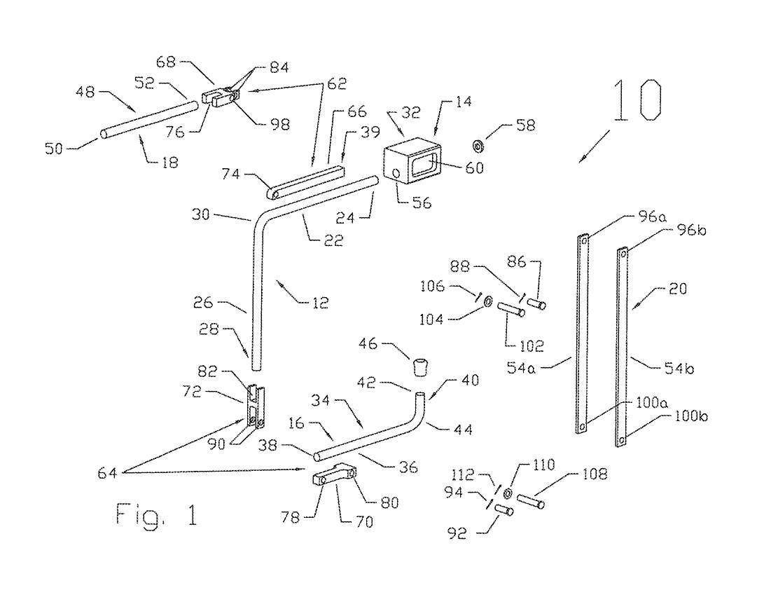

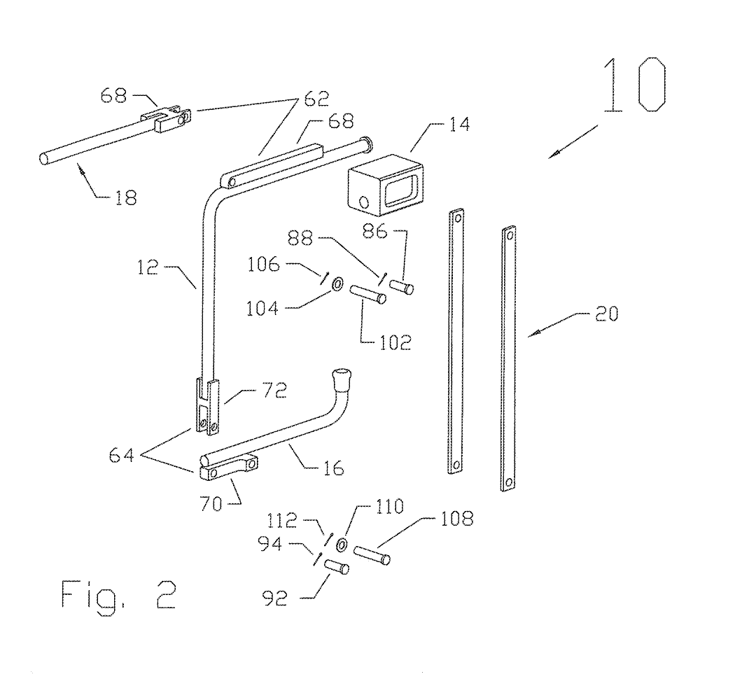

The number 10 generally indicates an embodiment of the wheel-supporting device made in accordance with the present invention. With reference to FIG. 1, a fully exploded perspective view of the individual component parts of device 10 is shown. With reference to FIG. 2, a partially exploded perspective view of device 10 is shown, specifically showing the various subassemblies of device 10 in an assembled state. The subassemblies of device 10 include a main body member 12, a holding means 14, an engaging means 16, an adjustment means 18, and a linking means 20.

In one or more embodiments, main body member 12 contains a first arm portion 22 having a first end 24 and a second arm portion 26 having a second end 28. First arm portion 22 and second arm portion 26 are substantially 90-degrees apart from one another, joined together at a bend 30.

In one or more embodiments, first arm portion 22 and second arm portion 26 are solid round bars or circular pipes made of a material selected from the group consisting of metal, plastic, polymeric materials, and combinations thereof. In one embodiment of the present invention, such as shown in the figures of the present invention, first arm portion 22 and second arm portion 26 are both solid round bars.

In one or more embodiments, holding means 14 comprises a rotatable height-adjusting block 32. As will be explained in more detail below, holding means 14 can be anything that will evenly distribute the downward force applied to the top of a tire when device 10 is engaged with a wheel rim. If the downward force applied to the top of the tire by holding means 14 is not evenly distributed, then holding means 14 could pinch the top of the tire, leading to an improper seating of the beads of the tire when device 10 is engaged with the wheel rim. In other embodiments of the present invention, holding means 14 could be a long flat extension connected to first end 24 of first arm portion 22, or instead of being a solid round bar, such as shown in the figures of the present invention, the entirety of first arm portion 22 could be a long and flat piece of metal, plastic, or polymer.

In one or more embodiments, engaging means 16 is in the form of a lifting arm 34 wherein lifting arm 34 includes a first arm portion 36 having a first end 38 and a second arm portion 40 having a second end 42. First arm portion 36 and second arm portion 40 are substantially 90-degrees apart from one another, joined together at a bend 44. In one embodiment of the present invention, second end 42 may be covered with a non-skid and non-marring tip 46. As will be explained below in more detail, lifting arm 34 is adapted to lift a wheel in order to relieve pressure against the lower portion of the beads of a tire caused by the weight of the wheel in a standing tire/wheel assembly.

In one or more embodiments, first arm portion 36 and second arm portion 40 are solid round bars or circular pipes made of a material selected from the group consisting of metal, plastic, polymeric materials, and combinations thereof. In one embodiment of the present invention, such as shown in the figures of the present invention, first arm portion 36 and second arm portion 40 are both solid round bars.

In one or more embodiments, adjustment means 18 is in the form of a lever arm 48 having a first end 50 and a second end 52. As will be explained in more detail below, adjustment means 18 can be anything that will adjust engaging means 16 from being in a position adjacent the underside of a wheel rim, to a position engaged with the underside of a wheel rim. For example, adjustment means 18 could also be a threaded rod, a turnbuckle, a spring, or a strap, cord, or cable.

In one or more embodiments, lever arm 48 is a solid round bar or circular pipe made of a material selected from the group consisting of metal, plastic, polymeric materials, and combinations thereof. In one embodiment of the present invention, such as shown in the figures of the present invention, lever arm 48 is a solid round bar.

In one or more embodiments of the present invention, linking means 20 includes two linking arms 54a and 54b. As will be explained in more detail below, linking means 20 can be anything that pivotally connects the engaging means 16 to the adjustment means 18. For example, linking means 20 could also be a threaded rod, a spring, or a strap, cord, or cable.

As stated above, in one embodiment of the present invention, holding means 14 comprises a rotatable height-adjusting block 32. In one embodiment, rotatable height-adjusting block 32 is rotatably attached to the first end 24 of first arm portion 22 of main body 12. This rotatable attachment is accomplished by the first end 24 being slide through hole 56 of height-adjusting block 32 before a washer 58 is welded over first end 24 of first arm portion 22 of main body 12. In other embodiments, washer 58 may be attached to the first end 24 of first arm portion 22 of main body 12 in any manner, such as with a bolt into a threaded hole in the end of first end 24 of first arm portion 22 of main body 12 and/or applying a cotter pin through a hole in the first end 24 of first portion 22 of main body 12. Height-adjusting block 32 may include machined sides 60 for easier handling without slipping. Machined sides 60 may consist of recesses, knurls, or any pattern that enhances grip ability.

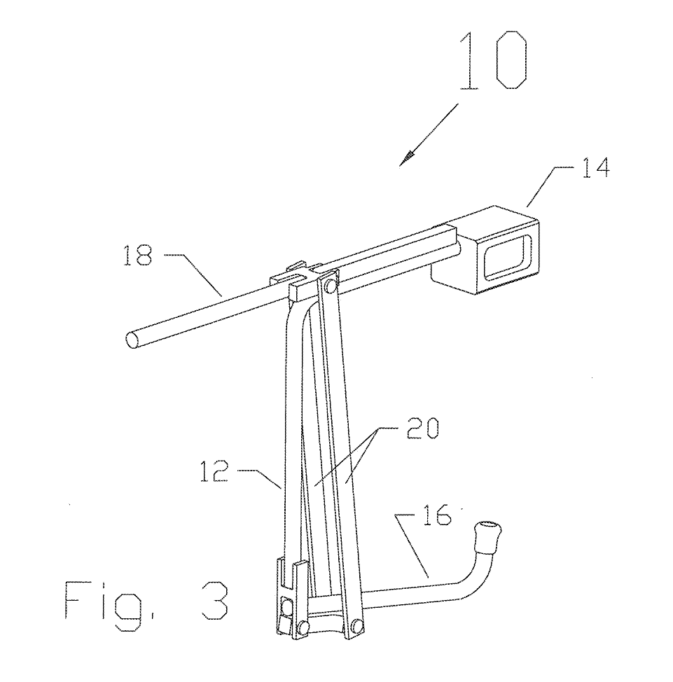

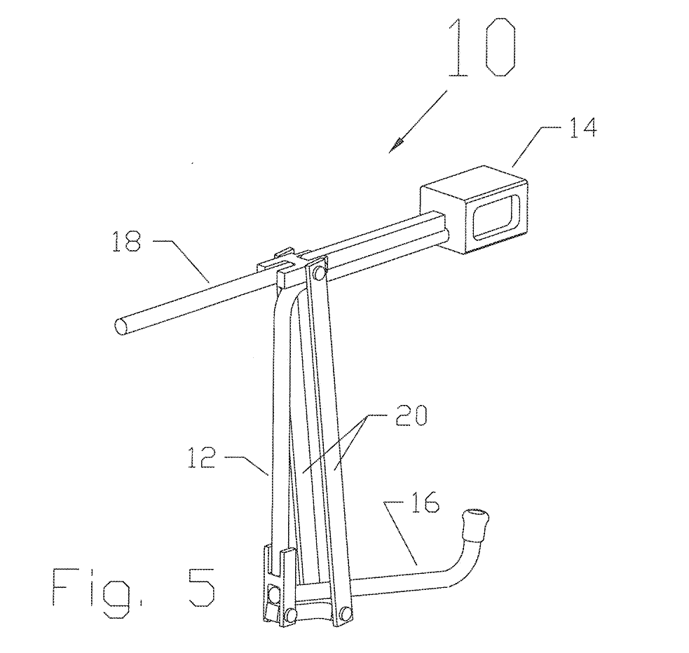

As shown in FIGS. 3, 4, 7a, and 8a, rotatable height-adjusting block 32 can be rotated into a first position which will allow for device 10 to be used with tire and wheel assemblies of a smaller size range, such as 11R22.5, 11R24.5, 295/75R22.5 and the like, as well as Super Wide Single sizes, such as 445/50R22.5. Additionally, as shown in FIGS. 5, 6, 9a, and 10a, rotatable height-adjusting block 32 can be rotated into a second position which will allow for device 10 to be used with tire and wheel assemblies of a larger size range, such as 12R22.5, 12R24.5 and the like, as well as Super Single sizes, such as 385/65R22.5, 315/80R22.5, and 455/55R22.5.

Connecting the various subassemblies together are a first connecting means 62 and a second connecting means 64. Specifically, first connecting means 62 pivotally connects the main body member 12, adjustment means 18, and the linking means 20 together; and the second connecting means 64 pivotally connects the main body member 12, engaging means 16, and the linking means 20 together. The first and second connecting means 62 and 64 can be any type of connector that allows the various subassemblies to work in combination with one another. In one embodiment of the present invention, such as shown in FIGS. 1-6, 7A, 8A, 9A, and 10A, the first connecting means 62 is a clevis type connector and the second connecting means 64 is also a clevis type connector.

The first clevis type connector 62 comprises a first clevis rod 66 and a first clevis bracket 68 and the second clevis type connector 64 comprises a second clevis rod 70 and a second clevis bracket 72.

In use, the first clevis rod 66 is attached to first arm portion 22 of main body member 12. In one or more embodiments, first clevis rod 66 is attached to first arm portion 22 by any means that securely attaches first clevis rod 66 to the first arm portion 22. In one embodiment, first clevis rod 66 is welded to first arm portion 22. First clevis rod 66 is attached to first arm portion 22 such that aperture 74 is accessible. Second end 52 of lever arm 48 is attached to first clevis bracket 68. Specifically, second end 52 of lever arm 48 is attached inside gap 76 of first clevis bracket 68. In one or more embodiments, second end 52 of lever arm 48 is attached inside gap 76 by any means that securely attaches second end 52 inside gap 76. In one embodiment, second end 52 of lever arm 48 is welded into position within gap 76 of first clevis bracket 68.

Second clevis rod 70 is attached to lifting arm 34. In one or more embodiments, second clevis rod 70 is attached to lifting arm 34 by any means that securely attaches second clevis rod 70 to lifting arm 34. In one embodiment, second clevis rod 70 is welded to lifting arm 34. Second clevis rod 70 is attached to lifting arm 34 such that apertures 78 and 80 are accessible. Second end 28 of second arm portion 26 of main body member 12 is attached to second clevis bracket 72. Specifically, second end 28 of second arm portion 26 is attached inside gap 82 of second clevis bracket 72. In one or more embodiments, second end 28 of second arm portion 26 is attached inside gap 82 by any means that securely attaches second end 28 inside gap 82. In one embodiment, second send 28 of second arm portion 26 is welded into position within gap 82 of second clevis bracket 72.

Once the various aspects of the first and second connecting means 62 and 64 have been attached to the various subassemblies of device 10, the various subassemblies of device 10 can start being connected to one another. Specifically, first clevis rod 66 will connect to first clevis bracket 68 so as to connect main body member 12 to lever arm 48 and second clevis rod 70 will connect to second clevis bracket 72 so as to connect main body member 12 to lifting arm 34.

First clevis rod 66 connects to first clevis bracket 68 by the alignment of aperture 74 of first clevis rod 66 between the apertures 84 of the first clevis bracket 68. Once aperture 74 is aligned with apertures 84, short clevis pin 86 is inserted through the aligned apertures, and then a cotter pin 88 is applied through short clevis pin 86. Second clevis rod 70 connects to second clevis bracket 72 by the alignment of aperture 78 of second clevis rod 70 between apertures 90 of the second clevis bracket 72. Once aperture 78 is aligned with apertures 90, short clevis pin 92 is inserted through the aligned apertures, and then a cotter pin 94 is applied through short clevis pin 92.

Next, upper apertures 96a and 96b of the two linking arms 54a and 54b of linking means 20 will align with aperture 98 of first clevis bracket 68 and lower apertures 100a and 100b of the two linking arms 54a and 54b of linking means 20 will align with aperture 80 of second clevis rod 70. Once all apertures are aligned, long clevis pin 102 will be inserted through aperture 96b of linking arm 54b of linking means 20, aperture 98 of first clevis bracket 68, aperture 96a of linking arm 54a of linking means 20, and washer 104, and then cotter pin 106 is applied through long clevis pin 102; then, long clevis pin 108 will be inserted through aperture 100b of linking arm 54b of linking means 20, aperture 80 of second clevis rod 70, aperture 100a of linking arm 54a of linking means 20, and washer 110, and then cotter pin 112 is applied through long clevis pin 108. Once all this is done, device 10 will be assembled and ready to use to lift and support the wheel of a tire/wheel assembly in a standing position in order to facilitate and ensure the concentric seating of a tire bead.

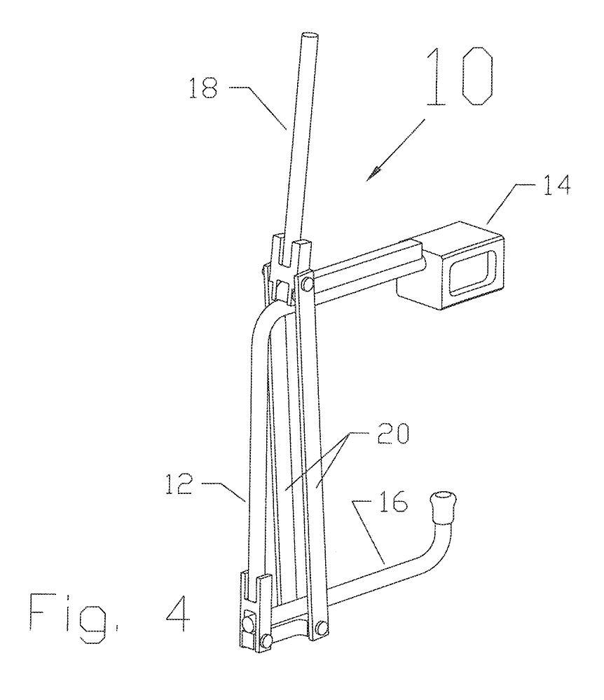

As shown in the differences between FIGS. 3 and 4, when the holding means 14 is in a first position, in order to raise the relative position of the engaging means 16, adjusting means 18 needs to be adjusted from a first position (FIG. 3) to a second position (FIG. 4), wherein the first position corresponds to the engaging means 16 being in a relatively low position, and the second position corresponds to the engaging means 16 being in relatively higher position.

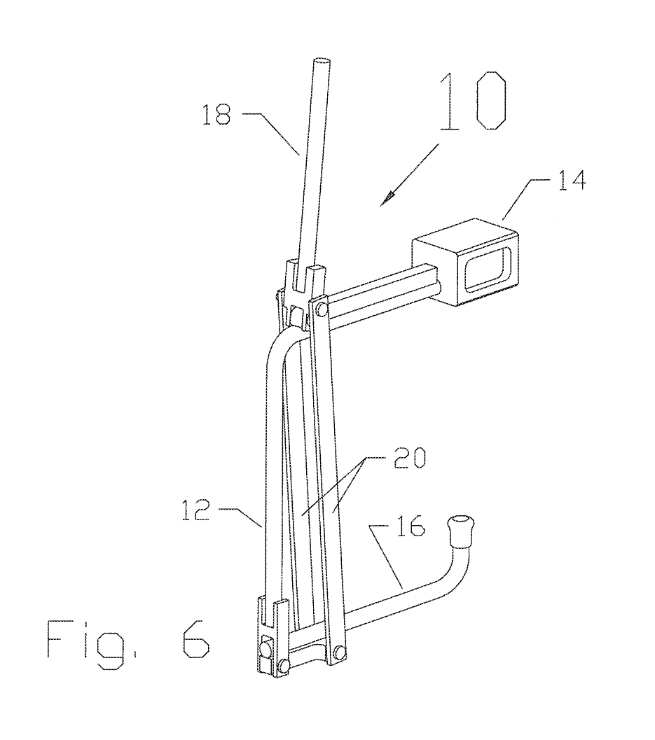

Similarly, as shown in the differences between FIGS. 5 and 6, when the holding means 14 is in a second position, in order to raise the relative position of the engaging means 16, adjusting means 18 needs to be adjusted from a first position (FIG. 5) to a second position (FIG. 6), wherein the first position corresponds to the engaging means 16 being in a relatively low position, and the second position corresponds to the engaging means 16 being in relatively higher position.

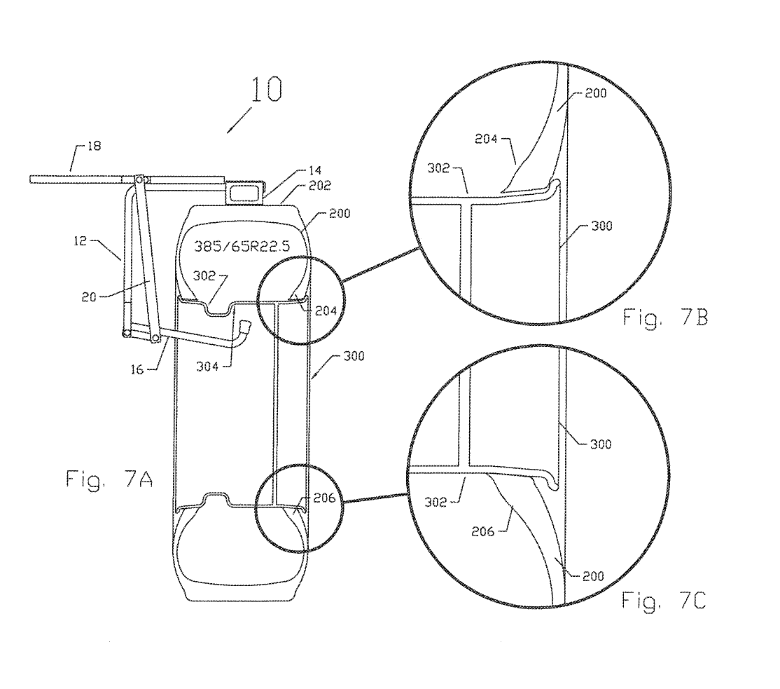

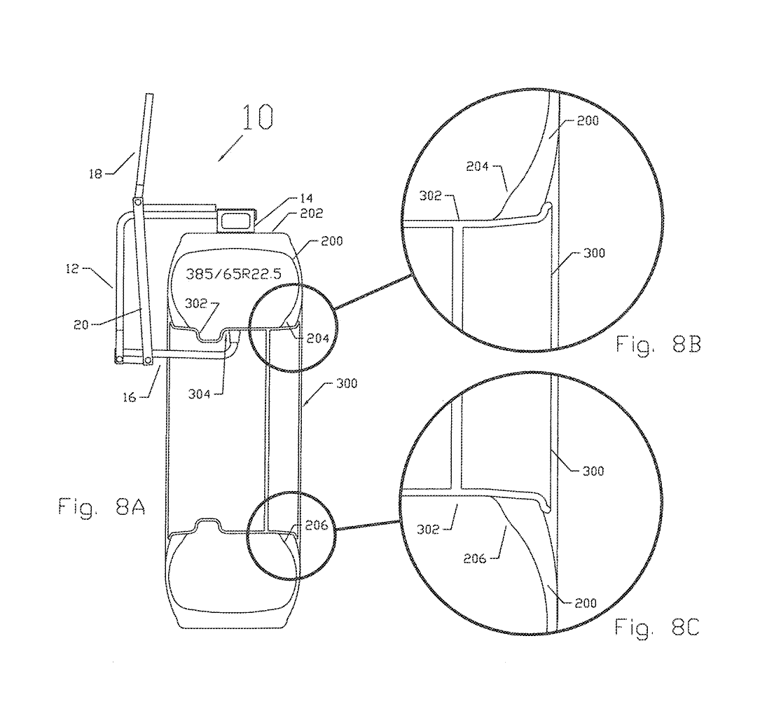

FIGS. 7A-8C show device 10, when holding means 14 is in a first position, being utilized to facilitate and ensure the concentric seating of a tire bead of a tire/wheel assembly in a standing position. FIG. 7A shows device 10 with holding means 14 in a first position and positioned on a top surface 202 of a tire 200. FIG. 7A also shows engaging means 16 in a position adjacent the underside 304 of a wheel rim 302 of a wheel 300. FIG. 7B shows how the bead 204 at or near the top of the tire 200 is not sitting flush against wheel rim 302 of wheel 300. FIG. 7C shows how wheel rim 302 of wheel 300 is sitting against the bead 206 at or near the bottom of the tire 200 in an improper manner because the bead is not seated correctly. This improper seating is due to the heavy weight of the wheel rim 302 being forced down on bead 206 at or near the bottom of the tire 200. FIGS. 7A-7C show what happens when adjustment means 18 is in its first position, such as clearly shown in FIG. 7A.

FIG. 8A shows device 10 with holding means 14 in a first position and positioned on a top surface 202 of a tire 200 and engaging means 16 in an engaged position with the underside 304 of the wheel rim 302 of wheel 300. Engaging means 16 being placed into the engaged position occurs when the adjustment means 18 is adjusted into a second position, such as clearly shown in FIG. 8A. With adjustment means 18 in a second position such that the engaging means 16 is placed into an engaged position, the bead of tire 200 is now concentrically centered on the wheel rim 302 of wheel 300. The concentric centering of both the bead 204 at or near the top of the tire 200 and the bead 206 at or near the bottom of the tire is shown in FIGS. 8B and 8C, respectively.

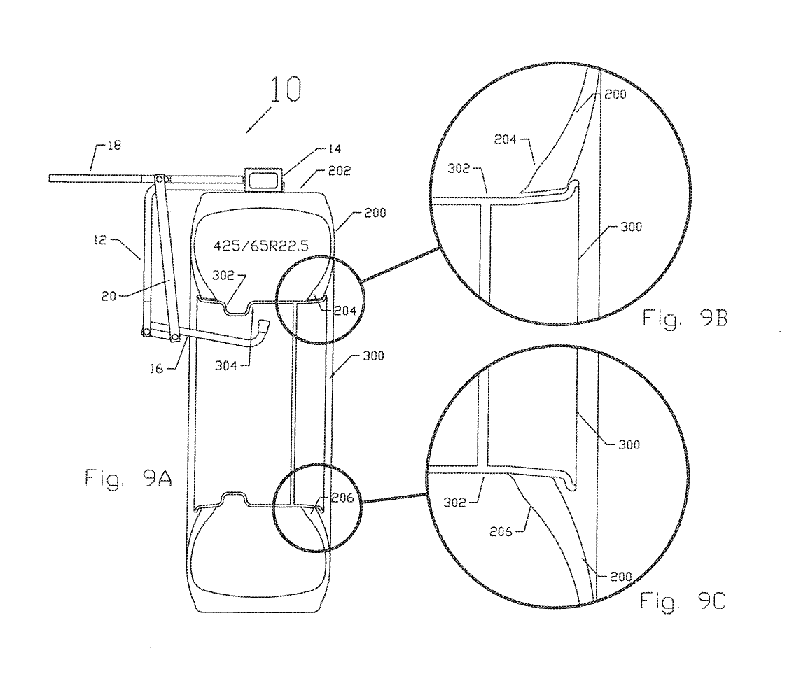

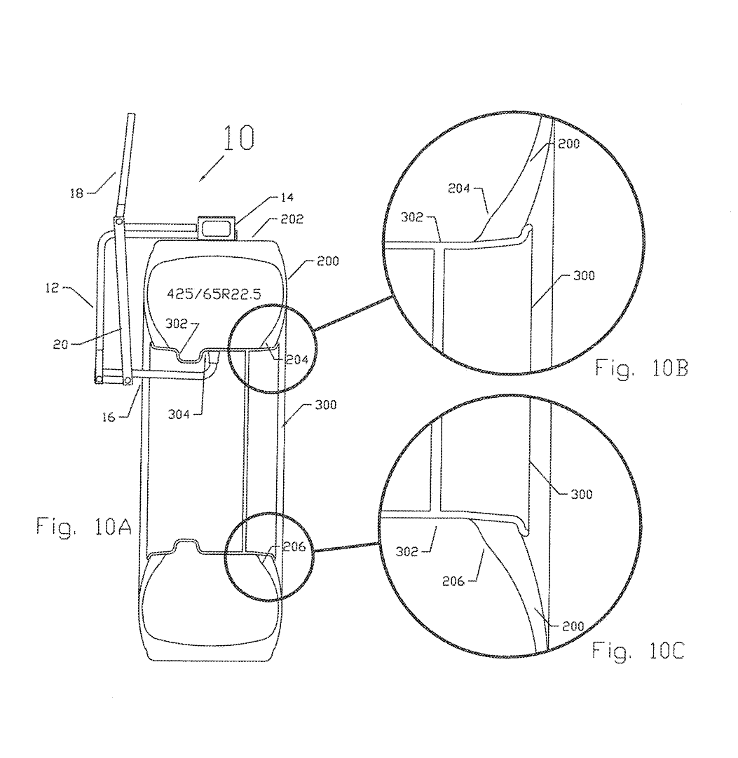

FIGS. 9A-10C show device 10, when holding means 14 is in a second position, being utilized to facilitate and ensure the concentric seating of a tire bead of a tire/wheel assembly in a standing position. FIG. 9A shows device 10 with holding means 14 in a second position and positioned on a top surface 202 of a tire 200. FIG. 9A also shows engaging means 16 in a position adjacent the underside 304 of a wheel rim 302 of a wheel 300. FIG. 9B shows how the bead 204 at or near the top of tire 200 is not sitting flush against wheel rim 302 of wheel 300. FIG. 9C shows how wheel rim 302 of wheel 300 is sitting against the bead 206 at or near the bottom of the tire 200 in an improper manner because the bead is not seated correctly. This improper seating is due to the heavy weight of the wheel rim 302 being forced down on bead 206 at or near the bottom of the tire 200. FIGS. 9A-9C show what happens when adjustment means 18 is in its first position, such as clearly shown in FIG. 9A.

FIG. 10A shows device 10 with holding means 14 in a second position and positioned on a top surface 202 of a tire 200 and engaging means 16 in an engaged position with the underside 304 of the wheel rim 302 of wheel 300. Engaging means 16 being placed into the engaged position occurs when the adjustment means 18 is adjusted into a second position, such as clearly shown in FIG. 10A. With adjustment means 18 in a second position such that the engaging means 16 is placed into an engaged position, the bead of tire 200 is now concentrically centered on the wheel rim 302 of wheel 300. The concentric centering of both the bead 204 at or near the top of the tire 200 and the bead 206 at or near the bottom of the tire 200 is shown in FIGS. 10B and 10c, respectively.

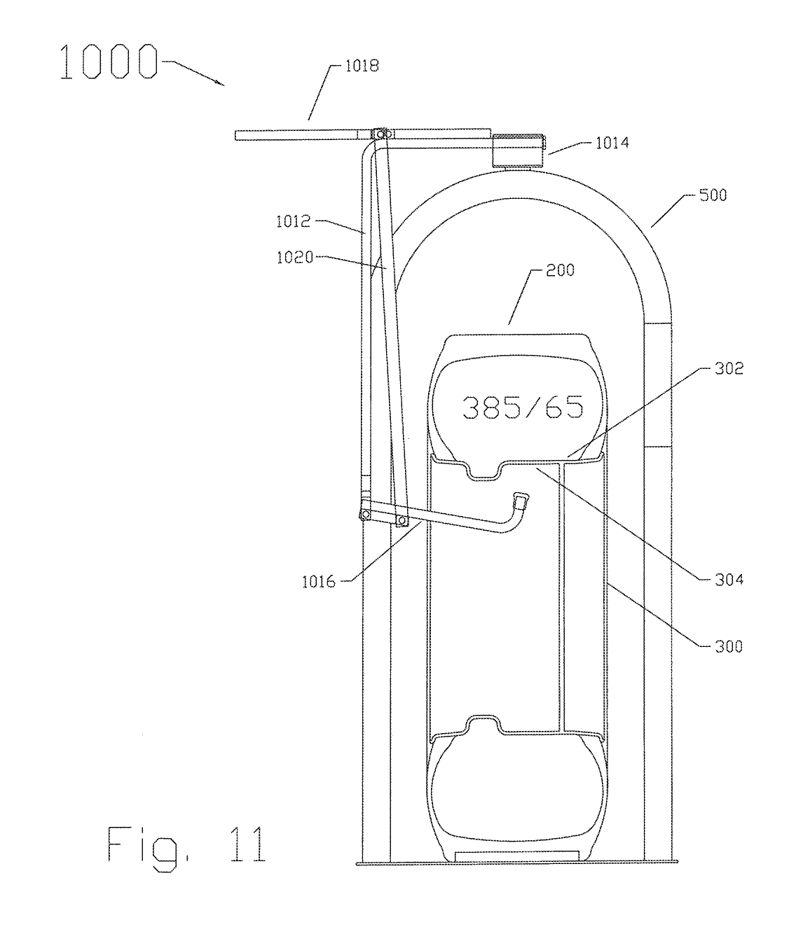

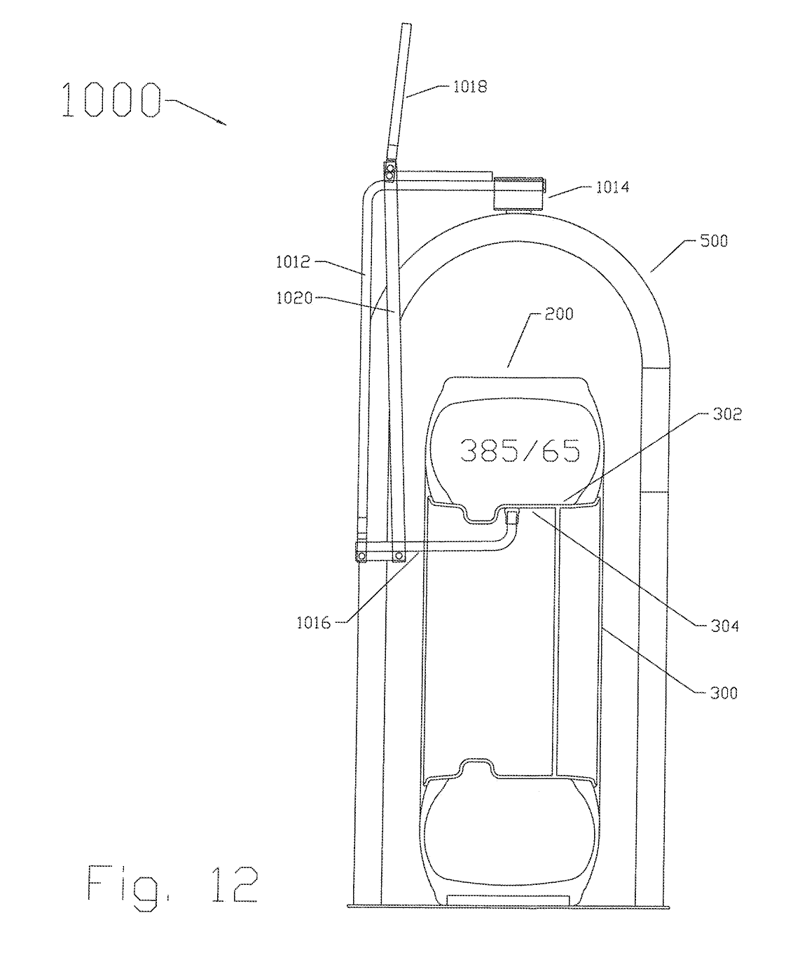

The number 1000 generally indicates an embodiment of the wheel-supporting device made in accordance with the present invention. With reference to FIGS. 11 and 12, device 1000 includes a main body member 1012, a holding means 1014, and engagement means 1016, an adjustment means 1018, and a linking means 1020. Device 1000 is similar to device 10 described above except that device 1000 is of a larger size than device 10 such that device 1000 can be used so as to enable the seating of a bead of a tire concentrically on a wheel rim of a wheel and tire assembly when the assembly is in a vertical orientation and the assembly is placed within a tire cage. By larger, it will be appreciated that main body member 1012 and linking means 1020 are of a length that is longer than the previous device and of sufficient length to extend from below the rim 302 of the wheel 300 to above the top of the tire cage 500. Accordingly it will be appreciated that, in as least one embodiment, both the main body member and/or the linking means may be of more than one piece construction so as to further adjust the length of the main body member 1012 and linking means 1020. To that end, the linking means and/or main body member could include springs to aid in adjusting their lengths.

FIG. 10 shows device 1000 with holding means 1014 positioned on the top of a tire cage 500. FIG. 10 also shows engaging means 1016 in a position adjacent the under side 304 of a wheel rim 302 of a wheel 300 and adjustment means 1018 in a first position. FIG. 11 shows device 1000 with holding means 1014 positioned on the top of a tire cage 500 and engaging means 1016 in an engaged position with the underside 304 of the wheel rim 302 of wheel 300. Engaging means 1016 being placed into the engaged position occurs when the adjustment means 1108 is adjusted into a second position, such as clearly shown in FIG. 11. With adjustment means 1018 in a second position such that the engaging means 1016 is placed into an engaged position, the bead of tire 200 is now concentrically centered on the wheel rim 302 of wheel 300.

In light of the foregoing, it should be appreciated that the present invention significantly advances the art by providing a wheel supporting device and a method of using a wheel supporting device for concentrically centering beads of a tire on a wheel rim of a wheel and tire assembly when the assembly is in a vertical orientation that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A wheel supporting device for enabling the seating of a bead of a tire concentrically on a wheel rim of a wheel and tire assembly when the assembly is in a vertical orientation, the device comprising:
a. a main body member having a first end and a second end;
b. a means for holding the device on a top of the tire, said holding means connected to the first end of the main body member;
c. a means for engaging the device with an underside of the wheel rim, said engaging means operatively connected to the second end of the main body member;
d. a means for adjusting the position of the engaging means, said adjusting means operatively connected to the main body member; and
e. a means for linking the engaging means with the adjusting means.

2. The device of claim 1, wherein the holding means is rotatably connected to the first end of the main body member.

3. The device of claim 2, wherein the holding means is a rotatable height-adjusting block.

4. The device of claim 3, wherein the height adjusting block is rotatable between a first position and a second position such that the first position corresponds to a wheel of a first size and the second position corresponds to a wheel of a second size.

5. The device of claim 1, further comprising a first connecting means operatively connecting the engaging means to the second end of the main body member and a second connecting means operatively connecting the adjusting means to the main body member.

6. The device of claim 5, wherein the linking means is secured to both the first connecting means and the second connecting means.

7. The device of claim 6, wherein the adjustment means is adjustable to a first position and a second position, wherein the first position corresponds to the engaging means being in a non-engaged position with the underside of the wheel rim and the second position corresponds to the engaging means being in an engaged position with the underside of the wheel rim.

8. The device of claim 7, wherein the engaged position corresponds to the beads of a tire being concentrically seated on the wheel rim.

9. The device of claim 6, wherein both the first and second connecting means is a clevis connector.

10. The device of claim 1, wherein the linking means comprises two parallel linking arms.

11. The device of claim 1, wherein the engaging means is a lifting arm.

12. The device of claim 11, wherein the lifting arm includes a non-skid and non-marring tip member covering an end of the lifting arm.

13. The device of claim 1, wherein the adjustment means is a lever arm.

14. A method for concentrically centering beads of a tire on a wheel rim of a wheel and tire assembly when the assembly is in a vertical orientation, the method comprising the steps of:
a. providing a wheel supporting device comprising:
i. a main body member having a first end and a second end;
ii. a means for holding the device on a top of the tire, said holding means connected to the first end of the main body member;
iii. a means for engaging the device with an underside of the wheel rim, said engaging means operatively connected to the second end of the main body member;
iv. a means for adjusting the position of the engaging means, said adjusting means operatively connected to the main body member; and
v. a means for linking the engaging means with the adjusting means;
b. placing the wheel supporting device in a position such that the holding means are positioned on the top of the tire and the engaging means are in a position adjacent the underside of the wheel rim; and
c. adjusting the adjustment means such that the engaging means moves and engages the underside of the wheel rim so as to concentrically center the bead of the tire on the wheel rim.

15. A wheel supporting device for enabling the seating of a bead of a tire concentrically on a wheel rim of a wheel and tire assembly when the assembly is in a vertical orientation and placed within a tire cage, the device comprising:
a. a main body member having a first end and a second end;
b. a means for holding the device on a top of the tire cage, said holding means connected to the first end of the main body member;
c. a means for engaging the device with an underside of the wheel rim, said engaging means operatively connected to the second end of the main body member;
d. a means for adjusting the position of the engaging means, said adjusting means operatively connected to the main body member; and
e. a means for linking the engaging means with the adjusting means.

16. The device of claim 15, further comprising a first connecting means operatively connecting the engaging means to the second end of the main body member and a second connecting means operatively connecting the adjusting means to the main body member.

17. The device of claim 16, wherein the linking means is secured to both the first connecting means and the second connecting means.

18. The device of claim 17, wherein the adjustment means is adjustable to a first position and a second position, wherein the first position corresponds to the engaging means being in a non-engaged position with the underside of the wheel rim and the second position corresponds to the engaging means being in an engaged position with the underside of the wheel rim, and wherein the engaged position corresponds to the beads of a tire being concentrically seated on the wheel rim.

19. The device of claim 16, wherein both the first and second connecting means is a clevis connector.

20. The device of claim 15, wherein the linking means comprises two parallel linking arms, wherein the engaging means is a lifting arm including a non-skid and non-marring tip member covering an end of the lifting arm, and wherein the adjustment means is a lever arm.
